(19) United States
(12) Patent Application Publication
(10) Pub. No.: US 2007/0012345 A1
(43) Pub. Date: Jan. 18, 2007

(54) Lower limb-support ambulatory device

(76) Inventor: Tony Leroy Owens, Independence, OR (US)

Correspondence Address: ATER WYNNE LLP, 222 SW COLUMBIA, SUITE 1800, PORTLAND, OR, 97201-6618, US

(21) Appl. No.: 11/525,359

(22) Filed: Sep. 22, 2006

Related U.S. Application Data
(63) Continuation-in-part of application No. 11/041,502, filed on Jan. 24, 2005.

(51) Int. Cl. A61H 3/02

(52) U.S. Cl. 135/69

(57) ABSTRACT

A lower limb, e.g. bent knee, supporting device includes a lower limb supporting brace including at an upper extreme thereof and aligned with a long axis thereof a cushioned limb support member; an elongate angled stabilizing handle or member for stabilizing the brace, the handle extending upwardly and outwardly from the brace at an angle thereto, the handle being securely grippable by a user without use of the armpit; the device including below the stabilizing member and brace at a lower extreme thereof a tip configured to frictionally engage an ambulatory surface. The device includes one or more grippable members aligned axially or transversely along an upper gripping region of the handle. The handle extends to a height intermediate the user's waist and armpit so that the upper grip can be squeezed between the user's arm and torso, thus freeing both hands for other uses. The height of the limb support member is adjustable so that its concave upper surface can cup a bent knee of a user with the lower leg extending behind. The upper transverse gripping member and the limb support member are height and pivotal orientation adjustable for fit. The device is lightweight and the handle provides significant leverage in positioning, aligning and securing the device to the lower limb so that a substantial fraction of the user's weight is borne by the limb support member.

### RELATED APPLICATIONS

The present continuation-in-part patent application claims priority from co-pending U.S. patent application Ser. No. 11/041,502, entitled LOWER LIMB-SUPPORT AMBULATORY DEVICE and filed Jan. 24, 2005, the disclosure of which is incorporated herein in its entirety by this reference.

### BACKGROUND OF THE INVENTION

This invention relates generally to the field of apparatus for a cane, walker or crutches used by the physically injured or disabled as an aid to ambulating (walking), the cane usually being held in one hand, the walker usually being held in two hands and the crutches being held one in either hand and being thrust under either armpit.

### SUMMARY OF THE INVENTION

A lower limb, e.g. bent knee, supporting device includes a lower limb supporting brace including at an upper extreme thereof and aligned with a long axis thereof a cushioned limb support member; an elongate vertical stabilizing handle or member for stabilizing the brace, the handle extending outwardly at a predefined angle from the lower limb supporting brace's long axis, the handle being securely grippable by a user without use of the armpit; the brace including at a lower extreme a tip configured to frictionally engage an ambulatory surface. The device includes one or more grippable members aligned axially or transversely along an upper region of the handle. The handle extends to a height intermediate the user's waist and armpit so that the upper grip can be squeezed between the user's arm and torso, thus freeing both hands for other uses. The height of the limb support member is adjustable so that its concave upper surface can cup a bent knee of a user with the lower leg extending behind. The upper transverse gripping member and the limb support member are height and pivotal orientation adjustable for fit. The device is lightweight and the handle provides significant leverage in positioning, aligning and securing the device to the lower limb so that a substantial fraction of the user's weight is borne by the limb support member.

### BRIEF DESCRIPTION OF THE DRAWINGS

FIGS. 1A and 1B are front elevations of the knee support ambulatory device in use by a user who is standing on, exercising, ambulating (walking) or resting his injured leg, FIG. 1A showing the device in one-handed operation and FIG. 1B showing the device in no-handed or hands-free operation.

FIGS. 2A and 2B are front elevations of the knee support ambulatory device according respectively to a first and second embodiment of the present invention.

FIGS. 3A and 3B are side elevations of the knee support ambulatory device according respectively to the first and the second embodiments of the present invention.

FIG. 4 is an isometric view of the knee support ambulatory device in use by a seated user who is sitting and resting his injured leg.

FIG. 5 is a top plan view of the knee support ambulatory device according to the second embodiment of the invention, illustrating the pivotal adjustability of the upper transverse grippable collar and the cushioned limb support member featured therein.

FIGS. 6A and 6B are front elevations of the knee support ambulatory device according respectively to the first and the second embodiment of the invention, contrasting the relative balance achieved by the two embodiments.

### DETAILED DESCRIPTION OF THE PREFERRED EMBODIMENTS

The invention in accordance with a preferred embodiment involves a singular lower limb-support, e.g. a bent-knee support, device that is somewhat similar to a conventional crutch but that allows one or both hands to be free to carry or use objects. Those of skill in the art will appreciate that conventional crutches are used in bilateral pairs, with the top curved surfaces thrust into either armpit by the user's two-handed grip on the crutch pairs' handles.

Thus, the advantages of the invented device over conventional crutches include a) avoiding nerve damage from pressure to the armpit, wrist and hand areas caused by placing unnecessary weight or strain on these areas of the user's body; and b) avoiding atrophy of the upper half of the injured leg by continually exercising the same during use of the invented device.

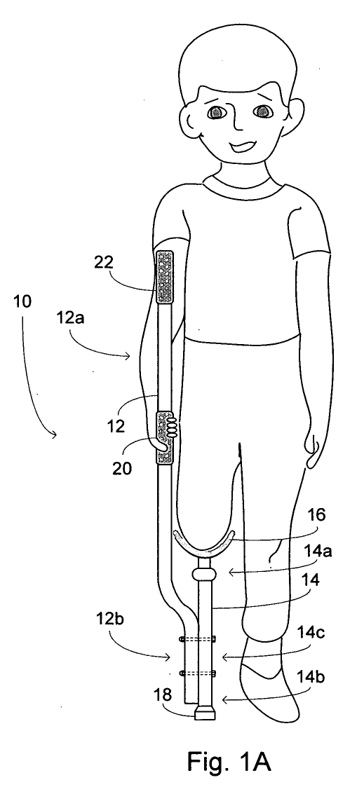

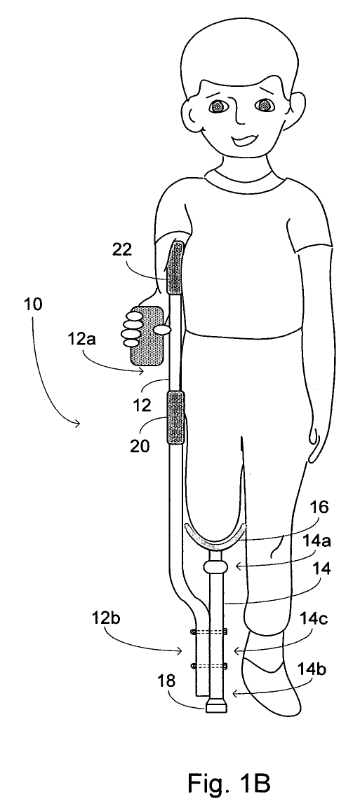

FIGS. 1A, 1B, 2A, 3A and 4 illustrate a knee support ambulatory device made in accordance with a first embodiment of the invention that has been discovered to realize the advantages listed above.

FIGS. 1A and 1B illustrate the invented lower limb-support ambulatory device 10 in a front isometric view illustrating a user who may be standing, exercising, ambulating (walking) or resting, FIG. 1A showing the device in one-handed operation and FIG. 1B showing the device in no-handed operation. FIGS. 1A and 1B are illustrative of device 10 in one embodiment of the invention and its use in accordance with one method of using the invention. Those of skill in the art will appreciate that alternative embodiments of the invention, as well as alternative methods of using the invention, are contemplated as being within the spirit and scope of the invention. For example, the invented device can be used to support the lower limb extremity of an amputee during a transitional phase of rehabilitation after amputation of a lower limb and before fitting of the lower limb with a prosthetic.

Invented device 10 may be understood to include a vertical member 12 configured to be grippable by a user in an upper region 12a thereof; and a lower limb support brace 14 affixed to vertical member 12, lower limb support brace 14 being configured at an upper extreme 14a thereof with a lower limb support member 16 to support, for example, a bent knee of the user. Lower limb support brace 14 includes at a lower extreme 14b thereof a tip 18 configured to frictionally engage an ambulation surface on which the user ambulates while gripping the vertical member with the bent knee, for example, reposing on the support member.

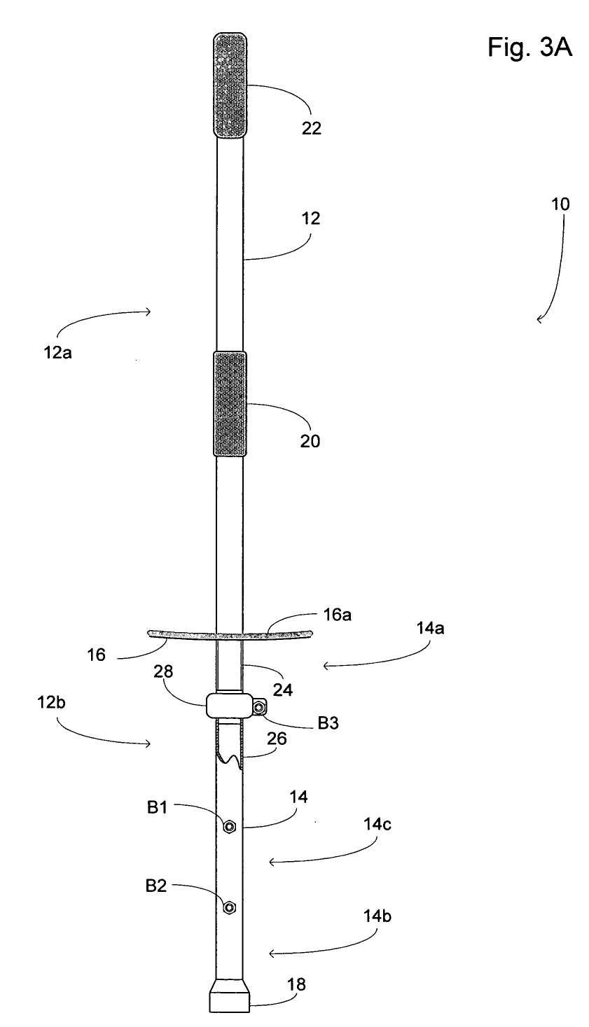

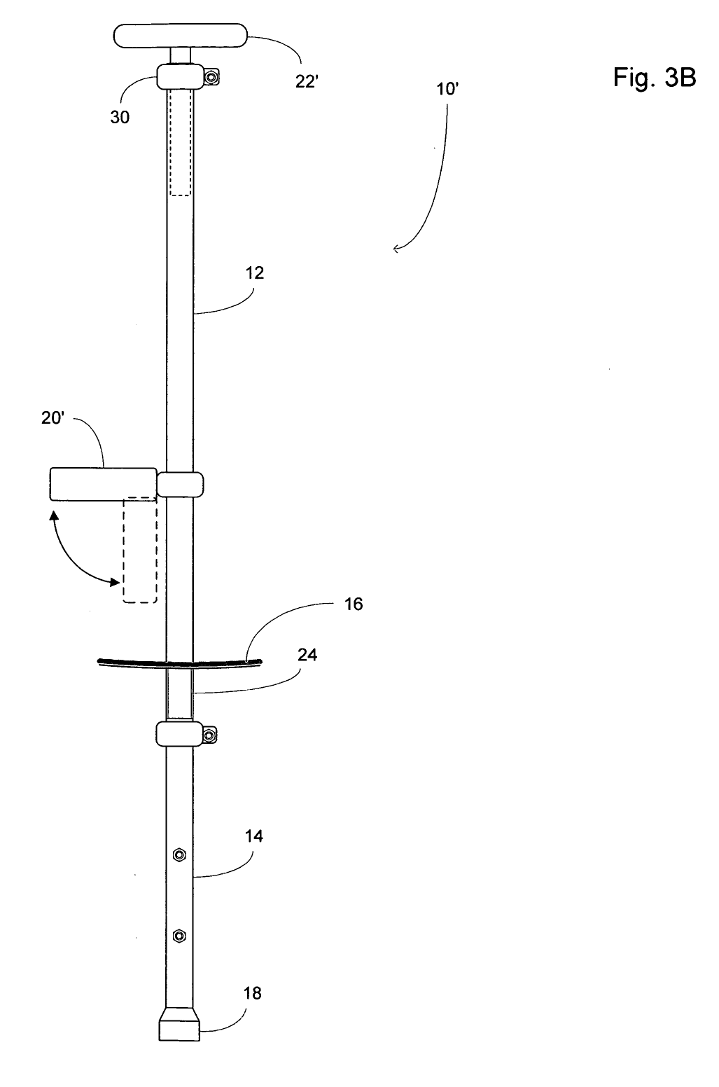

As may be seen from FIGS. 1A and 1B, vertical member 12 is elongate and includes at least one cushioned gripping collar or hand grip 20 aligned with its long vertical axis and optionally an additional cushioned gripping collar or hand grip 22 similarly aligned and positioned at an extreme upper end of vertical member 12. Also as may be seen from FIGS. 1A and 1B, lower limb support brace 14 is positioned laterally inwardly from vertical member 12 when the device is in use. Those of skill in the art will appreciate that this is true whether device 10 is used on the right or left side of the body to support a right or left lower limb such as a bent knee. As will be seen from FIG. 3, invented device 10 is substantially symmetric front to back, so that it is readily reversed left to right for use on either side.

It may be seen from FIGS. 1A and 1B that vertical member 12 is dimensioned relative the user such that its upper extreme (where optional gripping collar 22 is positioned) reaches a height on the user approximately intermediate his waist and armpit. This renders invented device 10 extremely easily manipulated by vertical member 12 to lift, pivot or otherwise stabilize lower limb brace 14. The mechanical advantage of leverage provides ease of use and secure but temporary fixation of the lower limb, e.g. the bent knee, within the lower limb support brace. Thus, the elongate vertical member effectively acts as a handle that positions, aligns and secures the support brace relative to the lower limb.

Briefly comparing and contrasting FIGS. 1A and 1B, it may be seen that lower grip 20 permits device 10 easily to be operated with one hand while upper grip 22 alternatively permits device 10 easily to be operated, at least over short distances, with no hand on lower grip 20. In other words, FIG. 1A illustrates one-handed operation of device 10 and FIG. 1B illustrates no-handed or hands-free operation of device 10. Thus, the user of device 10 in FIG. 1A grips the device lightly in one hand and accordingly has the other hand free but the user of identical device 10 in FIG. 1B squeezes the device lightly between his upper arm and torso and accordingly has both hands free, as indicated by the mug he carries in his right hand. The novel combination of the relatively vertical handle member (12) extending to an elevation approximately intermediate the user's waist and armpit, including the two or more grips (20, 22) spaced apart therealong, and aligned axially therewith, the lower limb support mechanism (14) and component parts of lightweight and preferably round, hollow, tubular material, renders possible such convenience. The ability to use a lower limb-support ambulatory device in this way represents an important advantage of the invention over conventional crutches.

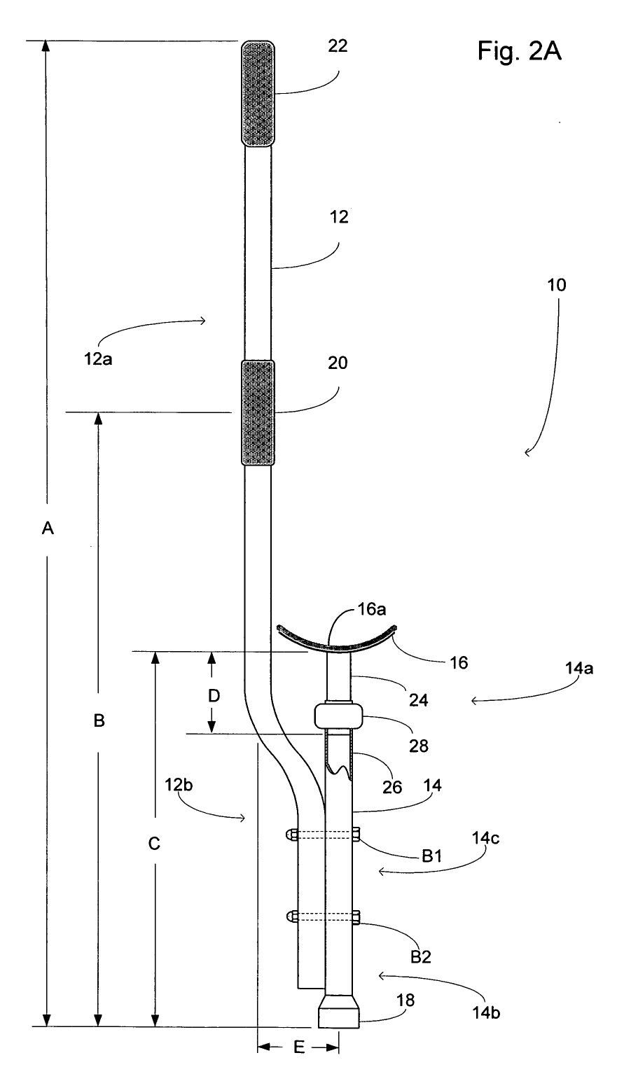

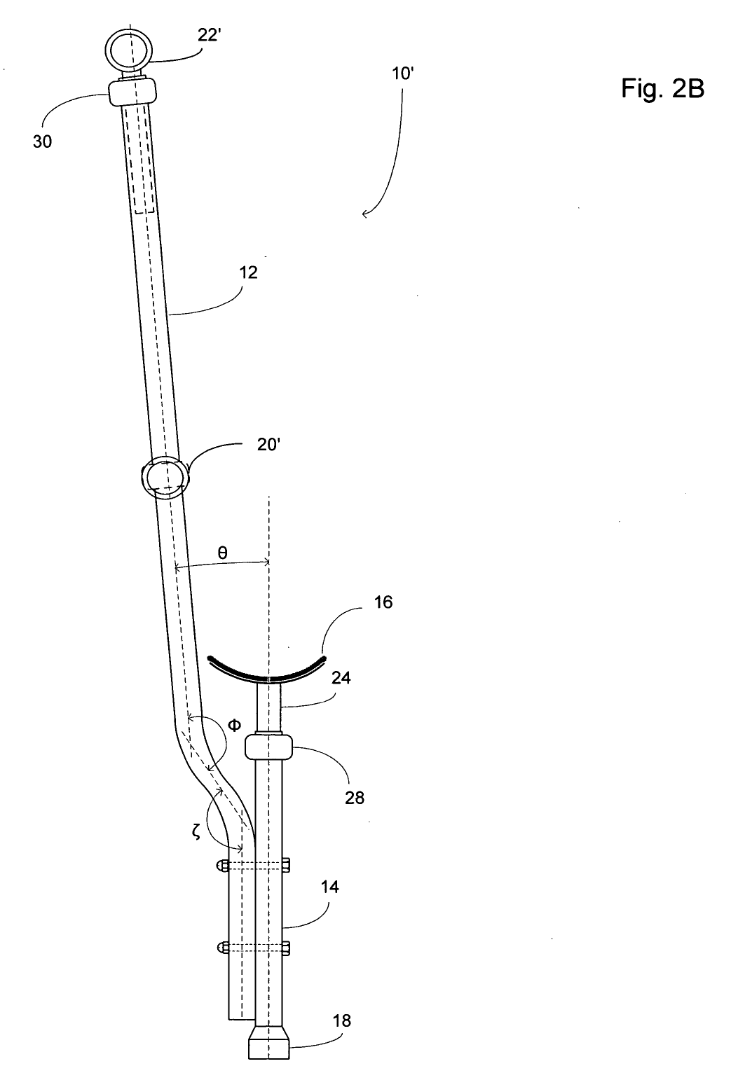

In accordance with one embodiment of the invention, as will be seen from FIGS. 2A and 3A, lower limb support member 16 preferably is height-adjustable relative to tip 18. Also, it will be understood that, in accordance with one embodiment of the invention, gripping collar 20 is slidably but securely height-adjustable along vertical member 12. (This is possible by use of a collar materially and structurally similar to a handlebar grip on a bicycle's steering wheel, as is known, whereby the collar has an interference fit with the hollow tubing sufficient to securely hold it in place against inadvertent sliding but insufficient to immobilize it against intentional sliding relative to the tubing.) Thus, invented device 10 accommodates a range of user sizes and preferences.

Referring collectively to FIGS. 2A and 3A, a first embodiment of invented device 10 will be described in structural and material detail. Those of skill in the art will appreciate that the detailed material and structural embodiment described and illustrated herein is intended to illustrate and not to limit the scope of the invention. For example, it will be seen that preferably vertical member 12 (also referred to herein as a stabilizing handle for stabilizing lower limb supporting brace 14) and lower limb support brace 14 are lengths of hollow aluminum tubing of circular cross section that are, along overlapping, parallel extents thereof, bolted together. Forming the major component parts of device 10 of hollow aluminum tubing renders the device lightweight, e.g. approximately 3 pounds overall, which helps achieve one of the advantages of the invention—easy employment and deployment in terms of grip, positioning, alignment, fixation and maneuverability. However, those of skill in the art will appreciate that the member and brace can be made of any suitable material that is lightweight and durable, e.g. titanium, graphite, fiberglass or plastic (e.g. PVC) or their combination. Those of skill in the art also will appreciate that the component parts can be differently affixed together or integrally molded or otherwise formed to provide an equivalent structure featuring lightweight but durable functionality, all within the spirit and scope of the invention.

In accordance with one embodiment of the invention, vertical member 12 includes a length of hollow, circularly cross-sectioned tubing that is generally S-shaped, as illustrated in FIG. 2A. Also in accordance with one embodiment of the invention, lower limb support brace 14 includes a length of hollow, circularly cross-sectional tubing that is generally straight. Vertical member 12 is configured to be placed near the upper right side or left side (when reversed front to back) of the user's torso, extending to a height A that is approximately intermediate the user's waist and armpit and extending downwardly and stepping laterally inwardly so that it generally parallels and conforms with the torso and leg of the user, as shown in FIG. 1A. Positioned in an upper region 12a of vertical member 12 and concentrically, axially aligned therewith is a collar-like grip 20 that is adjustably fixed at approximately the height B of the user's crotch so that the user's hands at rest with the user in a standing position are able to reach grip 20. Lower limb support brace 14 is positioned laterally inwardly from vertical member 12 and extends vertically from the ambulation surface to mount lower limb support member 16 to a height C thereabove. Preferably, height C of lower limb support member 16 is adjustable over a range D. Those of skill in the art will appreciate that the lateral, inward step represented by S-shaped vertical member 12 and the spacing between vertical member 12 and lower limb support brace 14 is of dimension E.

Those of skill in the art will appreciate that the dimensions represented by reference designators A, B, C, D and E in FIG. 2A are determined in part by the user's size and preference. Typically, for an adult user, the overall height A of device 10 is approximately four feet or forty-eight inches; the height B of hand grip 10 is approximately thirty inches; the height C of lower limb support member 16 is approximately eighteen inches; the range D of height adjustability of lower limb support member 16 is approximately five inches; and the dimension of the overall lateral inward step between vertical member 12 and lower limb support member 16 is approximately five inches. Any suitable dimensions are contemplated as being within the spirit and scope of the invention.

Different user heights, upper leg extents, torso shapes (body conformation) and preferences, within the spirit and scope of the invention, may make alternative dimensions more suitable to achieving the goals and advantages of the invention. For a user who is over six feet tall, e.g. 6′5″, height A of device 10 might be fifty-one or fifty-two inches or more, whereas for a user who is less than five feet tall, e.g. a child, height A of device 10 might be closer to 36″. Whatever the user's height, it is a great advantage of the invention that the upper extent of member 12 should be intermediate the user's waist and armpit, and not extend to the armpit. This is so that, while the device can easily be gripped and elevated during ambulation, nevertheless the user's weight is borne on the knee support by the injured lower limb rather than by the user's armpit.

It may be seen from FIGS. 2A and 3A that vertical member 12 in accordance with one embodiment of the invention in lower region 12b thereof is bolted (e.g. by two bolt/nut pairs B1, B2 extending through pairs of aligned holes, as illustrated best in FIG. 2) and corresponding nuts to a central region 14c of lower limb support brace 14. Alternative means of affixing or joining vertical member 12 and lower limb support brace 14 are contemplated as being within the spirit and scope of the invention. For example, they may be welded or glued or integrally formed as a single piece. Alternatively, a lower extreme of handle 12 may simply abut and join brace 14, as by welding or integrally molding both parts together as one, rather than having lower region 12b that runs in parallel therewith and is affixed thereto in region 14c. Thus, it is within the spirit and scope of the invention to construct invented device 10 with more or fewer pieces affixed or formed in different ways.

Centrally mounted in axial alignment at an upper extreme of lower limb support brace 14 is lower limb support member 16. Those of skill in the art will appreciate that lower limb support member 16 provides a padded rest or stop for the lower limb of the user. Thus, it is preferably concave and generally semi-circular in shape from side to side and configured to receive and support, e.g. cup, a user's knee, as illustrated in the front elevational view of FIG. 2A. From FIG. 2A, it may be seen to be only slightly concave and only slightly generally semi-circular in shape from front to back, as illustrated in the side elevational view of FIG. 3A. Those of skill will appreciate that this difference in curvature of lower limb support member 16 effectively cups the lower limb and seats it properly therein to prevent lateral movement while it also cradles the lower limb, e.g. a bent knee of the user, and supports it properly thereon to accommodate fore and aft movement. Those of skill also will appreciate that lower limb support member 16 preferably conforms somewhat to the anatomy of the user's lower limb. Nevertheless, within the spirit and scope of the invention, it may be a simple shelf having no concavity or depression along either orthogonal axis.

In accordance with one embodiment of the invention, an upper, limb-confronting surface 16a of lower limb support member 16 is cushioned or padded to increase the comfort of the user of invented device 10. Such a cushion or pad may, within the spirit and scope of the invention, take the form of an adhered or integral laminar layer of conformable material such as polystyrene foam or the like. Any suitable surface material, of any desired durability and conformability, is contemplated as being within the spirit and scope of the invention.

As is evident from FIG. 1A, a user of the invented device places the lower limb, e.g. the bent knee, of the injured leg into the padded rest and places his or her weight onto the padded rest. The lower half of the user's leg, for example, can protrude to the rear. This allows the user to spread the weight of his or her body evenly between the non-injured leg and the lower limb, e.g. the bent knee, of the injured leg. The user squeezes hand grip 20 or pressure grip 22 with the hand or against the body, for example, to stabilize the lower limb support member 16 and, to the extent needed, ever so slightly to elevate the lower limb support member 16 so that the lower limb remains securely in place within padded rest (D) while the user stands, pivots, exercises, walks on or rests the injured leg. The invented ambulatory device in accordance with one embodiment of the invention is lightweight so that hand grip 20 or pressure grip 22 is all that is needed to easily stabilize, lift or otherwise maneuver the ambulatory device. Rubber tip 18 will be understood to provide traction against an ambulatory surface on which the user stands, exercises, walks or rests.

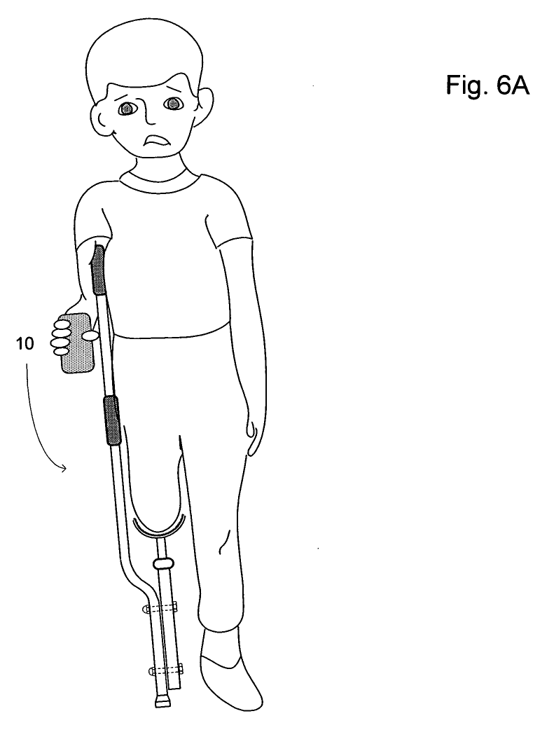

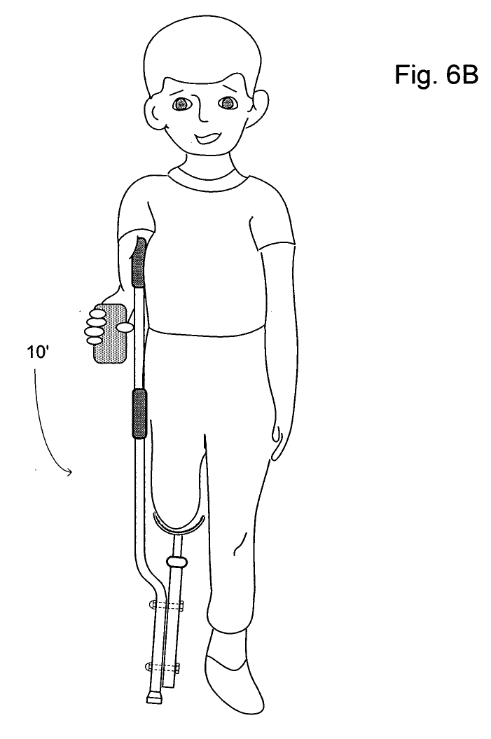

Two cushioned gripping members 20, 22 are provided, in accordance with one embodiment of the invention, in the form of collars. Lower (hand) grip or collar 20 provides a sure but comfortable hand grip at crotch level for manipulating vertical member 12 and for leveraging, positioning, aligning and securing lower limb support brace 14 between the lower limb of the user's leg and the ambulatory surface. In other words, lower (hand) grip 20 is used to hold onto invented device 10 and to maintain an upward force of lower limb, e.g. knee, support member 16 against the lower limb, e.g. the bent knee, while walking. Upper (pressure) grip or collar 22 may be included for aesthetics but it also serves a function: A user can squeeze it between the upper arm and the side of the chest or torso intermediate the waist and the underarm (see FIGS. 1B and 6B). This allows a user to carry an item such as a glass or mug or plate of food with either or both hands while walking for short distances using invented device 10. This ability to have both hands free during use is an extraordinary advantage of the invented device, and is a particularly novel feature of the invention.

Referring still collectively to FIGS. 2A and 3A, it will be understood that lower limb support member 16 is mounted in accordance with one embodiment of the invention in axial alignment with the congruent long axes of an inner support tube 24 and an outer support tube 26 that form a part of lower limb support brace 14. (Thus, lower limb support member 16 includes a central mounting region affixed on inner support tube 24 of lower limb supporting brace 14, thereby ensuring proper axial load-bearing of the user's weight.) Those of skill in the art will appreciate that this ensures the bulk of the user's weight is borne in axial alignment by the inner and outer support tubes, which will be understood to be the primary load-bearing members of device 10. Those of skill in the art will also appreciate that inner support tube 24 ‘telescopes’ within outer support tube 26, or smoothly slides along their congruent axes, in accordance with one embodiment of the invention, to facilitate height adjustment of lower limb support member 16 relative to tip 18. A desired height C of lower limb support member 16 thus is fixed above the ambulation surface by sliding inner support tube 24 within outer support tube 26 and tightening a bolt/nut combination B3 that forms a part of a height-adjustment clamp 28.

Those of skill in the art will appreciate that any suitable lower limb support member height adjustment mechanism is contemplated as being within the spirit and scope of the invention. For example, an Allen-head or equivalent set screw may be used instead of a clamp and bolt assembly in the illustrated embodiment, for better security. Or the height of the support member can be adjusted by adjusting the height of a single-tube support brace relative to the vertical member, e.g. by providing more than two spaced-apart through holes in one of the vertical extents to yield a range of height-relative mounting options between the lower limb support brace and the vertical handle member.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides means for more freedom in mobility, avoidance of damage to the user's wrist/hand and armpit areas; and exercise of the upper half of the injured leg that overcomes the deficiencies of known prior art devices. The invented device provides more freedom in mobility by allowing the use of one or both hands while walking (ambulating) with the device. The invented device provides a means of avoiding pain caused by nerve compression in the armpit area because none of the user's weight is supported by the armpit as is the case with conventional crutches. Similarly, wrist and hand pain are avoided because none of the user's weight is supported by the hands. The invented device inherently exercises the upper half of the injured leg because the user's normal body weight is supported by the knee and thigh of the injured leg.

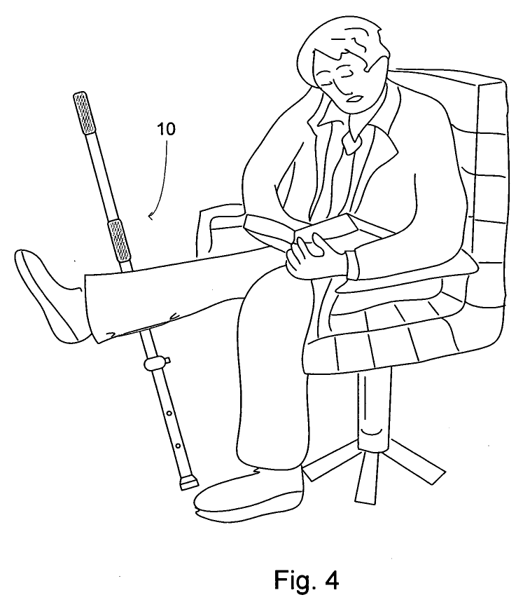

Moreover, from FIG. 4, it will also be understood that, in addition to providing the aforementioned advantages described above, the invented device can also be used as a foot rest to keep the injured leg elevated while the user is in a sitting position. Thus, a user of the invented device can use the device to elevate his or her injured leg while comfortably sitting down to rest. Those of skill in the art will appreciate that, by this method of use of the invention, cushioned lower limb support member 16 instead of serving to support the user's bent knee serves instead to comfortably support a rear lower region of the injured leg in a generally horizontal and extended configuration. It is generally known that injured limb extremities at rest heal more quickly when elevated relative to the heart due to increased circulation.

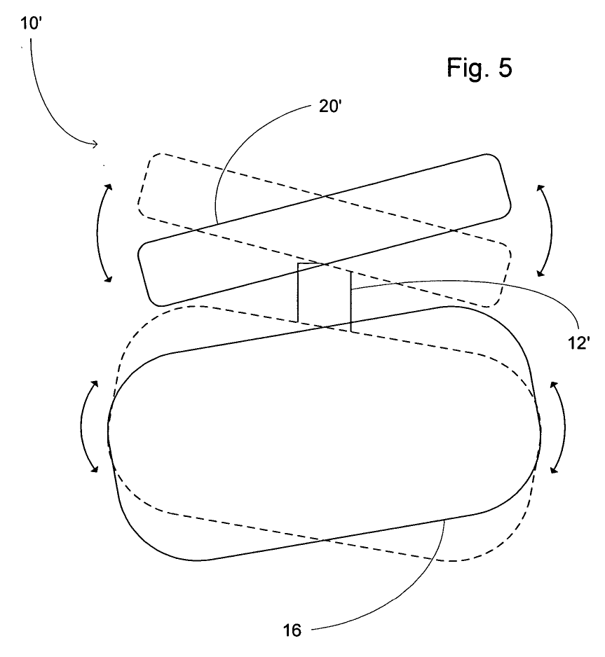

FIG. 5 illustrates a feature of the invented device by which lower limb support member 16 and upper grippable collar 22′ are pivotably adjustable to fit individual users. Pivotal adjustment is possible over a defined range of motion (indicated in FIG. 5 by curved arrows and dashed outlines) by loosening the corresponding clamp (not visible in FIG. 5, but clearly visible in FIGS. 2B and 3B) and rotating limb support member 16 and/or grippable collar 22′ as desired to improve the fit of the invented device to individual physiology, range of motion, musculature and comfort.

FIGS. 2B, 3B and 6B illustrate the invented ambulatory device of the invention in accordance with a second embodiment that represents certain improvements over the first embodiment. FIG. 6A shows that, with vertical member 12 extending in a vertical plane in parallel with lower limb support brace 14, an unsafe situation can occur wherein the (unhappy) user becomes unbalanced and can fall in the direction of the braced leg. This is because lower limb support brace ‘cambers out’ slightly when vertical member 12 is gripped as intended by the user. FIG. 6B in contrast shows that, with an angled member 12′ extending outwardly at an angle from the vertical plane and from the generally vertical axis of the lower limb support brace 14. Thus with this novel angled member 12′, lower limb support brace 14 is ‘cambered in’ slightly to restore or maintain the user's balance against falling.

FIGS. 2B and 3B illustrate a second embodiment of the invented ambulatory device 10′ featuring angled member 12′ and alternative gripping collars or members 20′ and 22′, the latter being adjustable for height and pivotal orientation by a second clamp 30 similar to first clamp 28 (and by providing a second telescopic tube pair arrangement similar to tube pair 24 and 26). Other features of this embodiment are identical to those of the first embodiment described above and below. The advantage of angled member 12′ that extends along most of its length straight upwardly and slightly outwardly is improved balance for the user, as discussed immediately above. In accordance with the second embodiment of the invention, the angle θ at which angled member 12′ extends out of vertical (laterally outwardly) is between approximately 3 and 7 degrees (3-7°) and preferably approximately 5°. While this may not seem like much of an angle, it represents a substantial improvement over the use of a nominally or relatively vertical member 12 because angled elongate member 12′ and elongate lower limb support brace 14 collectively form a V that, in use, tends to pivot the V-shaped device 10′ inwardly toward the user's body. This pivot or ‘camber in’ of brace 14 restores or maintains better balance for the user whose lower limb is weight-borne by knee support member 16.

(Those of skill in the art will appreciate that angles between the various straight segments of elongate member 12′ are shown in FIG. 2B. For example, the obtuse angle between the upper straight angled gripping portion of elongate member 12′ and the lateral step is represented as Φ while the obtuse angle between the lateral step and the lower vertical segment that is joined to brace 14 is represented as ζ. In accordance with the second embodiment of the invention described and illustrated herein, Φ is between approximately 148-152° and preferably approximately 150° while ζ is between approximately 143-147° and preferably approximately 145°. This angular combination produces the upward, slightly laterally outward angle θ from the vertical for the upper gripping region of elongate member 12′ of between approximately 3 and 7 degrees (3-7°) and preferably approximately 5°, as described above. Those of skill in the art also will appreciate that it is contemplated by the invention that these angles can be modified, within the spirit and scope thereof.)

FIGS. 2A and 2B also show alternative embodiments of gripping members 20′ and 22′. In accordance with this second embodiment of the invention, lower and preferably crotch-high member 20′ is pivotable into a transverse orientation relative stabilizing member 12′, e.g. generally horizontally, for lifting device 10 while the user is ambulating. If the user tries to place his or her weight on member 20′, however, it yields and pivots such that the user's weight is not borne by member 20′ but rather by knee support member 16 and brace 14. In this manner, member 20′ discourages or substantially prevents its use to bear the user's weight. It does so while facilitating lift of the device into constructive support, exercise and circulation of the user's injured lower limb. Those of skill in the art will appreciate that pivotal member 12′ is prevented from greater than 90° rotation (e.g. clockwise, in FIG. 3B) by a suitable stop or other comparable range-of-motion limiting structure (not shown). Those of skill in the art also will appreciate that, for left-handed operation of device 10′, member 12′ can very simply be rotated 180° around the long axis of handle 12′ so that it extends outwardly horizontally to be gripped by the user's left hand when the user's left lower limb or knee is cupped by knee support member 16.

Also in accordance with the second embodiment of the invention, upper member 22′ is oriented in a transverse orientation relative stabilizing member 12′, e.g. generally horizontally, for capture and stabilization of the stabilizing member at its upper extent between the user's arm and torso, e.g. intermediate his or her waist and armpit.

Those of skill in the art will appreciate that gripping members 20′ and 22′ can be made of any suitable material, within the spirit and scope of the invention, and may be provided with a frictionally engaging outer surface to increase purchase by the user's hand and upper arm. Those of skill in the art also will appreciate that gripping members 20′ and 22′ can be clamped as shown for height adjustment. Height and/or pivotal adjustment of gripping member 20′ can be accomplished by loosening a clamp and sliding and/or pivoting the gripping member relative to stabilizing member 12′. Height and/or pivotal adjustment of gripping member 22′ similarly can be accomplished by loosening a clamp and sliding and/or pivoting the gripping member relative to stabilizing member 12′, as by the illustrated telescopic arrangement.

As may be seen best from FIGS. 1A, 1B, 6A and 6B, the invented device provides little or no load-bearing purchase for its user. In other words, the grippable members, whether extending along the axis of stabilizing member 12 in the form of a collar or transverse thereto in the form of a grip, provide substantially only lateral purchase and the ability to laterally stabilize the device. Little or none of the user's weight is borne by stabilizing member 12, whether under the user's armpit, as with traditional crutches, or by the user's hand grip thereon. Accordingly, the user's weight is borne instead substantially by his or her legs, one on the floor or ground and the other on the provided knee support member. This prevents atrophy by exercising the injured limb, while also encouraging circulation that heals the injured limb.

The invented device thus allows a patient with a lower leg injury (one that involves injury below the knee) to move about without the problems incurred by the use of conventional crutches that are used in pairs. This device allows one hand to be free at all times and both hands to be free for short periods or distances. This device is lightweight and easily can be picked up, placed under the knee of the injured leg and stabilized for standing, walking, exercising or resting. There are no straps or fittings to be dealt with and, because the device is not strapped to the user, it can be easily set aside when the user sits down or otherwise does not need the device. Because of its substantial front-to-back (side elevational) symmetry, the device can be used on either the left or right leg. Conventional crutches require the patient to place a great deal of weight and strain on both wrists and hands as well as a great deal of weight on the armpit areas in order to support the weight of the person using them. This unnecessary burden of weight and strain generally causes more problems for the patient, including nerve damage in the wrist\hand and armpit areas. In accordance with the present invention, all of the patient's weight is placed on the lower limb, e.g. the bent knee, of the injured leg. This distributes the weight evenly across both knees and upper legs in the same way a person with no leg injury would experience.

While it is lightweight, the invented device is very of durable construction. Its weight-bearing member, i.e. the lower limb support brace, is oriented substantially in axial alignment with the user's upper leg, and is manipulated into position and alignment therewith by an elongate, grippable handle that obtains a mechanical advantage through leverage and that allows gripping by an extended hand for one free-handed operation or between an arm and torso for two free-handed operation. Moreover, the invented device has adjustable dimensions in critical fit areas to provide a range of suitable fits for various user sizes and preferences.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A lower limb-support ambulatory device comprising:
an elongate lower limb supporting brace including at an upper extreme a lower limb support member;
an elongate stabilizing handle for stabilizing the lower limb supporting brace, the stabilizing handle being securely grippable by a user while providing substantially no weight-bearing capacity;
the lower limb supporting brace including at a lower extreme a tip configured to frictionally engage an ambulatory surface on which the user ambulates;
the lower limb supporting brace and the stabilizing handle being joined to one another in a lower region of the stabilizing handle with the stabilizing handle extending slightly laterally outwardly and upwardly along an axis that generally forms a V with the long axis of the elongate lower limb supporting brace.

2. A lower limb-support ambulatory device comprising:
an elongate lower limb supporting brace including at an upper extreme a lower limb support member;
an elongate stabilizing handle for stabilizing the lower limb supporting brace, the stabilizing handle being securely grippable by a user without use of the armpit;
the lower limb supporting brace including at a lower extreme a tip configured to frictionally engage an ambulatory surface on which the user ambulates;
the lower limb supporting brace and the stabilizing handle being affixed to one another along parallel extents thereof with the stabilizing handle extending slightly laterally outwardly and upwardly along an axis the angle of which is different from the angle of the long axis of the elongate lower limb supporting brace.

3. The device of claim 2, wherein the lower limb support member includes a central mounting region affixed on the lower limb supporting brace in substantial alignment with a long axis of the lower limb supporting brace.

4. The device of claim 3, wherein the lower limb supporting brace includes first and second elongate members configured to slide and rotate relative to one another along a central elongate axis of the first and second members with one of the first and second members positioned inside the other of the first and second members, and wherein one of the first and second members is affixed to the lower limb support member in the central mounting region thereof, and wherein the first and second members are fixably adjustable relative to one another to adjust the height of the lower limb support member above the ambulatory surface and to adjust the orientation of the lower limb support member by pivotal counter-rotation of the first and second elongate slide-and-rotate members.

5. The device of claim 4, wherein the stabilizing handle includes an elongate member dimensioned to extend generally vertically to a height approximately intermediate the user's waist and armpit.

6. The device of claim 5, wherein the elongate member of the stabilizing handle includes a lateral step in a lower region thereof, the step spacing apart a long axis of an upper gripping region of the elongate member from the central axis of the first and second members of the lower limb supporting brace.

7. The device of claim 6 which further comprises:
one or more hand grips within the upper gripping region of the elongate member, the one or more hand grips providing traction for a user's grip thereon.

8. The device of claim 7, wherein an outer surface of the upper gripping region of the elongate member of the stabilizing handle is generally circular in cross section, and wherein the one or more hand grips include a generally circular hollow central region dimensioned to fixably slide along the outer surface of the upper gripping region of the elongate member of the stabilizing handle.

9. The device of claim 7, wherein at least one of the one or more hand grips extends substantially perpendicular to the long axis of the elongate member of the stabilizing handle.

10. The device of claim 9, wherein the at least one of the one of more hand grips pivots into a substantially horizontal orientation compatible with gripping when lifted upwardly and pivots into a substantially vertical orientation incompatible with gripping when pressed downwardly.

11. The device of claim 7, wherein the lower limb support member includes a smoothly curved semicircular concavity in an upper surface thereof, a radius describing the semicircle extending along the user's lower limb.

12. The device of claim 11, wherein the one or more hand grips are two or more, at least one of which is positioned along the upper gripping region approximately at the height of the user's crotch and at least another of which is positioned at the extreme upper end of the upper gripping region, wherein the two or more hand grips are padded. for comfort.

13. The device of claim 12, wherein the lower limb support member in the upper surface thereof and at least partway across the concavity is padded for comfort.

14. The device of claim 13, wherein at least the elongate member of the elongate stabilizing handle and the first and second members of the lower limb support brace are hollow generally circular tubes of a lightweight durable material taken from a group of materials including aluminum, titanium, graphite, fiberglass and plastic, alone or in combination.

15. A knee support ambulatory device comprising:
an elongate stabilizing member configured to be grippable by a user in an upper region thereof, the elongate stabilizing member extending along a stabilizing axis;
a knee support brace affixed to the stabilizing member, the knee support brace configured at an upper extreme thereof with a bent-knee support member to support a bent knee of the user, the knee support brace and the bent-knee support member collectively defining a load-bearing axis;
wherein the stabilizing axis extends upwardly and outwardly from a user's body and wherein the load-bearing axis extends upwardly and inwardly toward a user's body, and
a tip near a base of the device below the stabilizing member and the support brace, the tip configured to frictionally engage an ambulation surface on which the user ambulates while gripping the stabilizing member against the torso with the bent knee reposing on the bent-knee support member.

16. The device of claim 13, wherein the bent-knee support member is height-adjustable relative to the tip.

17. The device of claim 15, wherein the stabilizing member includes at least one cushioned gripping collar near its upper extreme.

18. The device of claim 17, wherein the gripping collar is aligned with the stabilizing member and is slidably but securely height-adjustable relative thereto.

19. The device of claim 15, wherein the stabilizing member includes plural cushioned gripping collars spaced apart along the upper gripping region thereof.

20. The device of claim 15, wherein the stabilizing member is hollow.

21. The device of claim 15, wherein the bent-knee support member is cushioned in an upper surface region thereof comfortably to support at least a substantial fraction of a body weight of the user on the bent knee thereof.

22. The device of claim 15, wherein the knee support brace is positioned laterally inwardly from the stabilizing member when the device is in use.

23. The device of claim 15, wherein the bent-knee support member is height-adjustable and orientation-adjustable relative to the tip and is cushioned in an upper surface region thereof comfortably to support at least part of a body weight of the user on the bent knee thereof, wherein the knee support brace is positioned laterally inwardly from the stabilizing member, and wherein the stabilizing member is hollow and includes at least one cushioned gripping member adjacent an upper extreme of the long axis of the stabilizing member, the at least one gripping member being securely height-adjustable and orientation-adjustable relative to the long axis of the stabilizing member.
